(19) United States
(12) Patent Application Publication
(10) Pub. No.: US 2020/0143609 A1
(43) Pub. Date: May 7, 2020

(54) SYSTEMS AND METHODS FOR DIAGNOSING FAULTS ASSOCIATED WITH THE USE OF A PRIMARY POWER SUPPLY AND A BACKUP POWER SUPPLY

(71) Applicant: GM Global Technology Operations LLC, Detroit, MI (US)

(72) Inventors: Vijay A. NEELAKANTAN, Rochester Hills, MI (US); Richard A. KULAS, Dexter, MI (US); Aubrey W. DOWNS, JR., Brighton, MI (US); Eric B. GACH, Clarkston, MI (US); Ligang ZHANG, Novi, MI (US)

(73) Assignee: GM Global Technology Operations LLC, Detroit, MI (US)

(21) Appl. No.: 16/182,970

(22) Filed: Nov. 7, 2018

(51) Int. Cl. G07C 5/08; H02M 3/155; B60R 16/033; H02J 9/06; F16H 63/34

(52) U.S. Cl. CPC G07C 5/0808; H02M 3/155; F16H 63/3458; H02J 9/06; B60R 16/033

(57) ABSTRACT

A power supply diagnostics system is disclosed. The power supply diagnostics system includes a first direct current to direct current (DC/DC) control module configured to change an output of a first variable DC/DC converter and a second DC/DC control module configured to change an output of a second variable DC/DC converter. The first and second variable DC/DC converters are connected to a load. The power supply diagnostics system also includes: a first timer module; a second timer module; a first voltage comparison module configured to (i) store a voltage measured at the load based on an output of the first timer module and (ii) begin sampling a plurality of voltages measured at the load base on an output of the second timer module; and a DC/DC status module configured to change an operating parameter of a vehicle based on a comparison of the voltage and the plurality of voltages.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicles with multiple power supplies and, more particularly, to systems and methods of determining the status of the power supplies.

A vehicle may include a first power supply that provides a direct current (DC) voltage to various loads located in the vehicle. The vehicle may also include a second power supply that also provides a DC voltage to the loads. The second power supply acts as a backup, allowing the loads to operate even if the first power supply malfunctions—for example, stops providing the DC voltage to the loads.

### SUMMARY

A power supply diagnostics system is disclosed. The power supply diagnostics system includes a first direct current to direct current (DC/DC) control module configured to change an output of a first variable DC/DC converter from a first voltage to a second voltage. The output of the first variable DC/DC converter is connected to a load. The power supply diagnostics system also includes a first timer module configured to set a first signal to first state when the output of the first variable DC/DC converter is the second voltage for a first predetermined period and a second DC/DC control module configured to change an output of a second variable DC/DC converter from a third voltage to a fourth voltage when the first signal is in the first state. The output of the second variable DC/DC converter is connected to the load. The power supply diagnostics system further includes: a second timer module configured to set a second signal to first state when the output of the first variable DC/DC converter is the second voltage for a second predetermined period; a first voltage comparison module configured to (i) store a fifth voltage measured at the load when the second signal is in the first state and (ii) begin sampling a plurality of voltages measured at the load when the first signal is in the first state; and a DC/DC status module configured to change an operating parameter of a vehicle based on a comparison of the fifth voltage and the plurality of voltages.

In other features, the first voltage comparison module is configured to set a first counter to zero in response to the second signal being in the first state and increment the first counter for each voltage of the plurality of voltages that is greater than the fifth voltage by a first predetermined threshold.

In further features, the power supply diagnostics system includes a third timer module configured to set a third signal to a first state when the output of the second variable DC/DC converter is the fourth voltage for a third predetermined period. The first voltage comparison module is configured to: stop sampling the plurality of voltages when the third signal is in the first state; compare a value of the first counter to a second predetermined threshold; set a fourth signal to a first state when the value of the first counter is less than or equal to the second predetermined threshold; and set the fourth signal to a second state when the value of the first counter is greater than the second predetermined threshold.

In yet further features, the DC/DC status module is configured to set a status of the second variable DC/DC converter to a fail when the third signal is in the first state and the fourth signal is in the first state and set the status of the second variable DC/DC converter to a pass when the third signal is in the first state and the fourth signal is in the second state.

In other features, sampling the plurality of voltages includes sampling the voltage at the load at a predetermined sampling frequency.

In yet other features, the first predetermined period is longer than the second predetermined period, the second voltage is lower than the first voltage, the third voltage is lower than the second voltage, and the fourth voltage is higher than the first voltage.

In other features, the power supply diagnostics system includes an action request module configured to: reset a second counter based on the state of an ignition of the vehicle; increment the second counter in response to receiving a request to perform an action; set a fifth signal to a first state when a value of the second counter is less than a third predetermined threshold; and set the fifth signal to a second state when the value of the second counter is equal to the third predetermined threshold. The power supply diagnostics system also includes a switch control module configured to close a first switch when the fifth signal is in the first state, and open the first switch and close a second switch when the fifth signal is in the second state. A first end of the first switch is electrically connected to the output of the first variable DC/DC converter and a first end of the second switch is electrically connected to the output of the second variable DC/DC converter.

In further features, the power supply diagnostics system includes a second voltage comparison module configured to: compare a sixth voltage associated with a second end of the first switch to a fourth predetermined threshold when the switch is open; set a status of the first switch to a pass when the sixth voltage is less than or equal to the fourth predetermined threshold; and set the status of the first switch to a fail when the sixth voltage is greater than the fourth predetermined threshold.

In yet further features, the power supply diagnostics system includes an action completion module configured to determine whether a requested action is completed when the fifth signal is in the second state. The DC/DC status module is configured to set the status of the second variable DC/DC converter to fail in response to the action completion module determining that the requested action is not completed.

In other features, the first switch and second switch are located in a transmission control module of the vehicle and the requested action includes shifting a transmission of the vehicle into park.

A power supply diagnostics method includes: changing an output of a first variable direct current to direct current (DC/DC) converter from a first voltage to a second voltage. The output of the first variable DC/DC converter is connected to a load. The method also includes measuring and storing, in response to changing the output of the first variable DC/DC converter to the second voltage, a third voltage at the load, and changing an output of a second variable DC/DC converter from a fourth voltage to a fifth voltage. The output of the second variable DC/DC converter is connected to the load. The method further includes in response to changing the output of the second variable DC/DC converter to the fifth voltage, measuring a plurality of voltages at the load, and setting an operating parameter of a vehicle based on a comparison of the third voltage and the plurality of voltages.

In other features, the power supply diagnostics method includes: setting a counter to zero in response to changing the output of the first variable DC/DC converter to the second voltage; for each voltage of the plurality of voltages that is greater than the third voltage by a first predetermined threshold, incrementing the counter; comparing a value of the counter to a second predetermined threshold; and setting the operating parameter of the vehicle includes, in response to determining that the value of the counter is less than a second predetermined threshold, setting a status for the second variable DC/DC converter to a fail.

In yet other features, the second voltage is lower that the first voltage, the fourth voltage is lower than the second voltage, and the fifth voltage is higher than the first voltage.

In other features, measuring the plurality of voltages includes sampling voltages at the load at a predetermined sampling frequency for a predetermined sampling period. In further features, the predetermined sampling frequency is 80 Hertz and the predetermined sampling period is one second.

A power supply diagnostics method includes closing a first switch of a controller. A first end of the first switch is electrically connected to an output of a first variable direct current to direct current (DC/DC) converter and a second end of the first switch is electrically connected to a driver of the controller. The method also includes receiving a request to perform an action and in response to receiving the request, selectively (i) opening the first switch and (ii) closing a second switch. A first end of the second switch is electrically connected to an output of a second variable DC/DC converter and a second end of the second switch is electrically connected to the driver. The method further includes determining whether the requested action is completed and in response to determining that the requested action is not completed, changing an operating parameter of a vehicle.

In other features, the power supply diagnostics method includes: in response to opening the first switch, measuring a voltage of the second end of the first switch; comparing the measured voltage of the second end of the first switch to a first predetermined threshold; and in response to determining that the measured voltage is greater than the first predetermined threshold, setting a status of the first switch to a fail.

In further features, the power supply diagnostics method includes: in response to receiving the request to perform an action, incrementing a counter; comparing a value of the counter to a second predetermined threshold; and selectively (i) opening the first switch and (ii) closing the second switch includes opening the first switch and closing the second switch in response to determining that the value of the counter is equal to or greater than the second predetermined threshold.

In yet further features, determining whether the requested action is completed includes receiving a sensor value associated with the requested action and determining whether the requested action is completed based on the received sensor value. Changing the operating parameter of the vehicle includes, in response to (i) opening the first switch, (ii) closing the second switch, and (iii) determining that the requested action is not completed, setting a status of the second variable DC/DC converter to a fail.

In other features, the controller is a transmission control module of a vehicle and completing the requested action includes shifting a transmission of the vehicle into park.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a functional block diagram of an example power supply diagnostics system;

FIG. 3 is a functional block diagram of an example controller with a driver of the power supply diagnostics system;

FIG. 4 is a functional block diagram of another example controller of the power supply diagnostics system;

FIG. 5 is a functional block diagram of an example power supply diagnostics module of power supply diagnostics system;

FIG. 6 is a graph showing example voltages over a period of time as measured by various voltage sensors of the power supply diagnostics system;

FIG. 7 is a flowchart depicting an example method of verifying that a power supply is able to provide power to a controller; and

FIG. 8 is a flowchart depicting an example method of verifying that a power supply is able to provide the current necessary for a controller to perform an action.

In the drawings, reference numbers may be reused to identify similar and/or identical elements.

### DETAILED DESCRIPTION

A vehicle may include a first power supply that provides a direct current (DC) voltage to various vehicle loads—for example a transmission control module (TCM) or another vehicle module. The vehicle may include a second power supply that also provides a DC voltage to the vehicle loads. The second power supply acts as a backup to the first power supply, allowing the vehicle loads to continue to operate in the event that the first power supply malfunctions. For example, the second power supply allows the TCM to shift a transmission of the vehicle into park, even when the first power supply stops providing the DC voltage to the vehicle loads.

According to the present disclosure, the vehicle may include a power supply diagnostics system. The power supply diagnostics system verifies that the vehicle loads are able to operate off of the voltage supplied by the second power supply in the event that the first power supply malfunctions. For example, the power supply diagnostics system may determine whether the second power supply is operating properly and is correctly connected to the vehicle loads. In the event that the power supply diagnostics system determines that the second power supply is malfunctioning or not correctly connected, the power supply diagnostics system may enable diagnostic trouble codes (DTCs) that limit the use of the vehicle until the issues related to the second power supply are corrected.

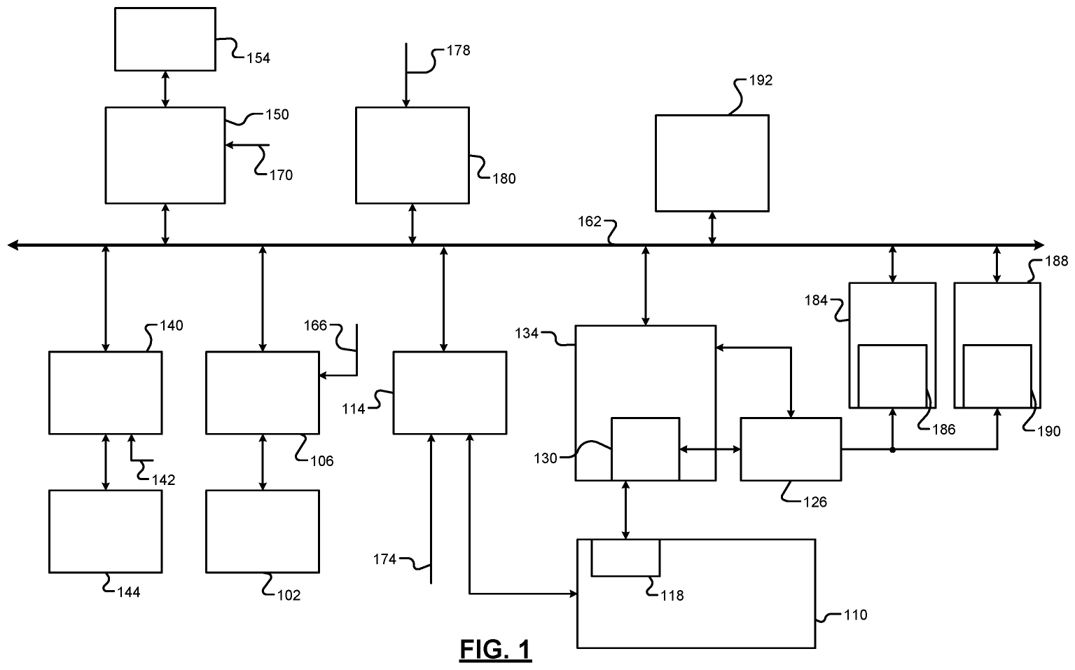

Referring now to FIG. 1, a functional block diagram of an example vehicle system is presented. While a vehicle system for a hybrid vehicle is shown and will be described, the present disclosure is also applicable to non-hybrid vehicles, electric vehicles, fuel cell vehicles, autonomous vehicles, and other types of vehicles. Also, while the example of a vehicle is provided, the present application is also applicable to non-vehicle implementations. For example, the disclosed systems and methods may be implemented in any system or device that includes redundant power supplies.

An engine 102 combusts an air/fuel mixture to generate drive torque. An engine control module (ECM) 106 controls the engine 102. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system may include one or more electric motors. For example, an electric motor 118 may be implemented within the transmission 110 as shown in the example of FIG. 1. An electric motor can act as either a generator or as a motor at a given time. When acting as a generator, an electric motor converts mechanical energy into electrical energy. The electrical energy can be used to charge a high voltage battery 126—for example, a 42 volt (V) battery, a 118 V battery, or a 300 V battery—via a power control device (PCD) 130. When acting as a motor, an electric motor generates torque that may be used, for example, to supplement or replace torque output by the engine 102. While the example of one electric motor is provided, the vehicle may include zero or more than one electric motor.

A power inverter control module (PIM) 134 may control the electric motor 118 and the PCD 130. The PCD 130 applies (e.g., DC) power from the high voltage battery 126 to the (e.g., alternating current) electric motor 118 based on signals from the PIM 134, and the PCD 130 provides power output by the electric motor 118, for example, to the high voltage battery 126. The PIM 134 may be referred to as a power inverter module (PIM) in various implementations.

A steering control module 140 controls steering/turning of wheels of the vehicle, for example, based on turning of a steering wheel within the vehicle and/or steering commands from one or more vehicle control modules. A steering wheel angle sensor (SWA) monitors rotational position of the steering wheel and generates a SWA 142 based on the position of the steering wheel. As an example, the steering control module 140 may control vehicle steering via an electronic power steering (EPS) motor 144 based on the SWA 142. However, the vehicle may include another type of steering system.

An electronic brake control module (EBCM) 150 may selectively control mechanical brakes 154 of the vehicle. Modules of the vehicle may share parameters via a controller area network (CAN) 162. The CAN 162 may also be referred to as a car area network. For example, the CAN 162 may include one or more data buses. Various parameters may be made available by a given control module to other control modules via the CAN 162.

The driver inputs may include, for example, an accelerator pedal position (APP) 166, which may be provided to the ECM 106. A brake pedal position (BPP) 170 may be provided to the EBCM 150. A position 174 of a park, reverse, neutral, drive lever (PRNDL) or another suitable range selector may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, and crank.

A primary power supply 184 converts power from the DC voltage of the high voltage battery 126 into a standard vehicle voltage to power 12 V vehicle loads. The primary power supply 184 includes a first variable DC/DC converter 186 that converts power from the DC voltage of the high voltage battery 126 into one or more other DC voltages—for example, 13.8 V or 12.7 V. By using the primary power supply 184, 12 V vehicle loads—such as the ECM 106, the TCM 114, the steering control module 140, the EBCM 150, or the BCM 180—do not need to be redesigned to work with the higher voltage output of the high voltage battery 126. In some implementations, the primary power supply 184 may be an auxiliary power module (APM).

A secondary power supply 188 also converts power from the DC voltage of the high voltage battery 126 into a standard vehicle voltage to power 12 V vehicle loads. Similar to the primary power supply 184, the secondary power supply 188 includes a second variable DC/DC converter 190 that converts power from the DC voltage of the high voltage battery 126 into one or more other DC voltages—for example, 12 V or 15.5 V. The secondary power supply 188 functions as a backup for the primary power supply 184. In other words, in the event that the primary power supply 184 fails, the 12 V vehicle loads can continue to operate on power provided by the secondary power supply 188. In some implementations, the secondary power supply 188 may be an APM.

A power supply diagnostics module (PSDM) 192 verifies that the second variable DC/DC converter 190 of the secondary power supply 188 is able to provide sufficient power to the 12 V vehicle loads so that they can properly function even when the first variable DC/DC converter 186 of the primary power supply 184 malfunctions—for example, stops outputting enough power to operate the loads. The PSDM 192 may verify that the 12 V loads are able to receive power from the secondary power supply 188. The PSDM 192 may perform this verification every time the vehicle is started. In other implementations, the PSDM 192 may perform the check again after a predetermined period of time—for example, 10 or 30 minutes. In addition, the PSDM 192 may verify that the power received from the secondary power supply 188 is sufficient to allow the 12 V load to properly operate. In other words, the PSDM 192 verifies that the secondary power supply 188 is able to supply a 12 V load with enough current to perform an action associated with the 12 V load. As an example only, the PSDM 192 may verify that the TCM 114 is able to shift the transmission 110 into park.

The vehicle may include one or more additional control modules that are not shown, such as a chassis control module, a battery pack control module, etc. The vehicle may omit one or more of the control modules shown and discussed.

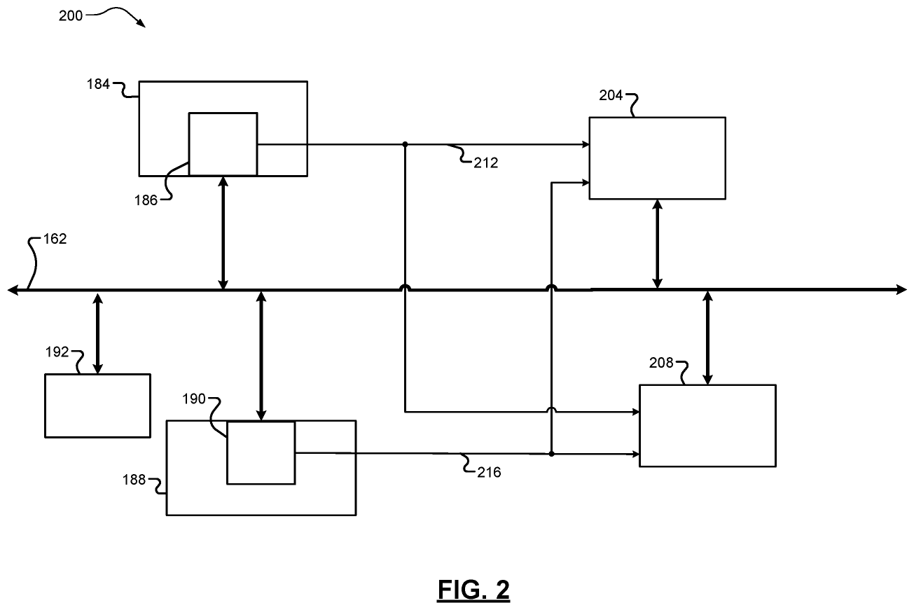

FIG. 2 is a functional block diagram of an example power supply diagnostics system 200. The power supply diagnostics system 200 may include the primary power supply 184, the secondary power supply 188, the PSDM 192, and a first controller 204. In some implementations, the first controller 204 may be the TCM 114. In other implementations, the first controller 204 may be the steering control module 140 or the EBCM 150. In yet other implementations, the first controller may be another 12 V load that performs an action that draws a high current from the secondary power supply 188.

In some implementations, the power supply diagnostics system 200 may also include a second controller 208. In an example implementation, the second controller 208 may be the ECM 106. In another example implementation, the second controller 208 may be the BCM 180.

The first variable DC/DC converter 186 of the primary power supply 184 supplies a primary output 212 to the first controller 204 and the second controller 208. The PSDM 192 may control the voltage of the primary output 212. The second variable DC/DC converter 190 of the secondary power supply 188 supplies a secondary output 216 to the first controller 204 and the second controller 208. The PSDM 192 may control the voltage of the secondary output 216. The PSDM 192 may vary the voltages of the primary output 212 and the secondary output 216 to verify that the secondary power supply 188 is both operating correctly and connected properly to the first controller 204 or the second controller 208—in other words, that the secondary power supply 188 is able to power the first controller 204 or the second controller 208.

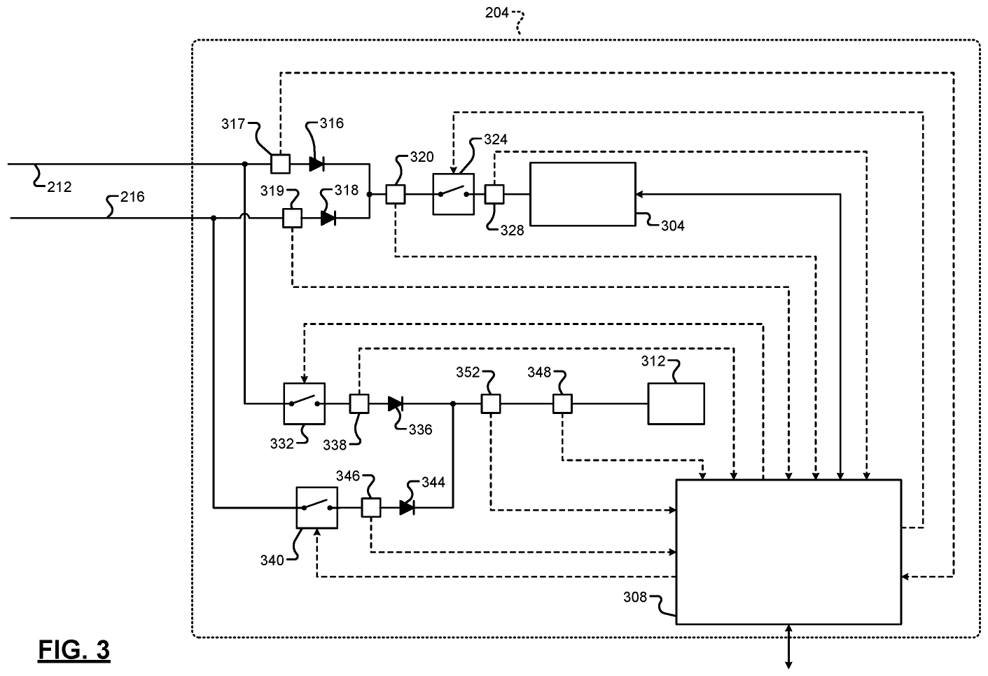

FIG. 3 is a functional block diagram of an example implementation of the first controller 204. The first controller 204 includes a first processor 304 in communication with a first networking module 308. The first networking module 308 sends and receives information via the CAN 162. In some implementations, the first networking module 308 may be a CAN chipset. The first controller 204 further includes a driver 312 in communication with the first networking module 308. In some implementations, the driver 312 may be an H-bridge that drives a motor (not shown). In other implementations, the driver 312 may be a circuit that drives a linear actuator or another electromechanical device.

The first controller 204 receives both the primary output 212 and the secondary output 216. The primary output 212 is connected to an anode of a first diode 316. The secondary output 216 is connected to an anode of a second diode 318. A first voltage sensor 317 measures the voltage of the anode of the first diode 316—the voltage of the primary output 212—and provides the value of measured voltage to the first networking module 308. A second voltage sensor 319 measures the voltage of the anode of the second diode 318—the voltage of the secondary output 216—and provides the value of the measured voltage to the first networking module 308.

The cathode of the first diode 316 is connected to the cathode of the second diode 318 and to a first current sensor 320. The first current sensor 320 is also connected to a first end of a first processor switch 324. A second end of the first processor switch 324 is connected to the first processor 304. The first current sensor 320 measures the current that flows from the cathodes of the first diode 316 and the second diode 318 to the first processor switch 324—in other words, the current drawn by the first processor 304 when the first processor switch 324 is closed. The first current sensor 320 provides the value of the measured current to the first networking module 308.

The first processor switch 324 is operated by the first networking module 308. The first networking module 308 may keep the first processor switch 324 open until a wake-up command is received—for example, from the ECM 106. In response to receiving the wake-up command, the first networking module 308 closes the first processor switch 324, such that the first processor 304 is electrically connected to the primary output 212 and the secondary output 216. In other words, the processor receives power from the primary power supply 184, the secondary power supply 188, or both the primary power supply 184 and the secondary power supply 188. A third voltage sensor 328 measures the voltage between the first processor switch 324 and the first processor 304. The third voltage sensor 328 provides the value of the measured voltage to the first networking module 308.

The primary output 212 is also connected to a first end of a first driver switch 332. A second end of the first driver switch 332 is connected to an anode of a third diode 336. A fourth voltage sensor 338 measures the voltage of the anode of the third diode 336—the voltage of the primary output 212 when the first driver switch 332 is closed—and provides the value of measured voltage to the first networking module 308.

The secondary output 216 is also connected to a first end of a second driver switch 340. A second end of the second driver switch 340 is connected to an anode of a fourth diode 344. A fifth voltage sensor 346 measures the voltage of the anode of the fourth diode 344—the voltage of the secondary output 216 when the second driver switch 340 is closed—and provides the value of the measured voltage to the first networking module 308.

A cathode of the third diode 336 is connected to a cathode of the fourth diode 344 and to the driver 312 via a second current sensor 348. The second current sensor 348 measures the current that flows from the cathodes of the third diode 336 and the fourth diode 344 to the driver 312—in other words, the current drawn by the driver 312. The second current sensor 348 provides the value of the measured current to the first networking module 308. A sixth voltage sensor 352 measures the voltage of the cathodes of the third diode 336 and the fourth diode 344. The sixth voltage sensor 352 provides the value of the measured voltage to the first networking module 308.

In some implementations, the first diode 316, the second diode 318, the third diode 336, and the fourth diode 344 may be Schottky diodes. In other implementations, the first diode 316, the second diode 318, the third diode 336, and the fourth diode 344 may be another diode with a low forward voltage drop and a fast switching speed. In some implementations, the first processor switch 324, the first driver switch 332, and the second driver switch 340 may be metal-oxide-semiconductor field-effect transistors (MOSFETs). In other implementations, the first processor switch 324, the first driver switch 332, and the second driver switch 340 may be relays or other suitable controllable switches.

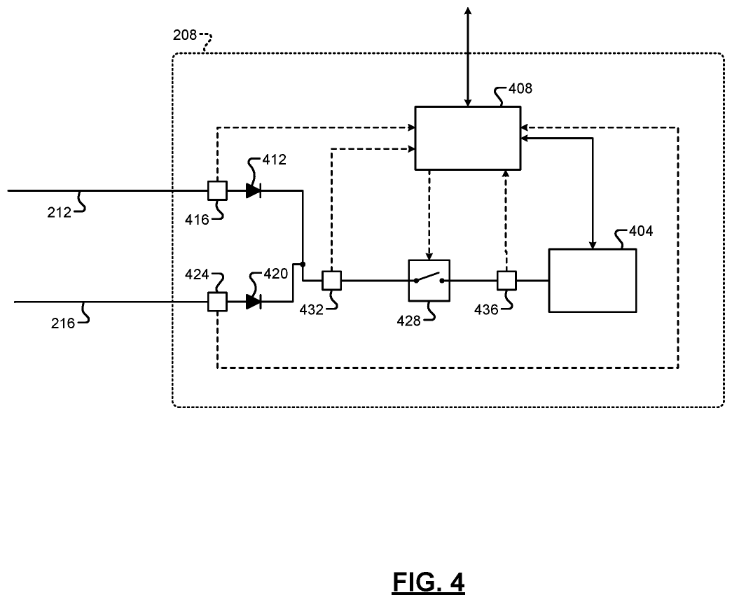

FIG. 4 is functional block diagram of an example implementation of the second controller 208. The second controller 208 includes a second processor 404 in communication with a second networking module 408. The second networking module 408 sends and receives information via the CAN 162. In some implementations, the second networking module 408 may be a CAN chipset. The second controller 208 receives both the primary output 212 and the secondary output 216. The primary output 212 is connected to an anode of a fifth diode 412. A seventh voltage sensor 416 measures the voltage of the anode of the fifth diode 412—the voltage of the primary output 212—and provides the value of measured voltage to the second networking module 408. The secondary output 216 is connected to an anode of a sixth diode 420. An eight voltage sensor 424 measures the voltage of the anode of the sixth diode 420—the voltage of the secondary output 216—and provides the value of the measured voltage to the second networking module 408.

A cathode of the fifth diode 412 is connected to a cathode of the sixth diode 420 and to a third current sensor 432. The third current sensor 432 is also connected to a first end of a second processor switch 428. A second end of the first processor switch 324 is connected to the first processor 304. The third current sensor 432 measures the current that flows from the cathodes of the fifth diode 412 and the sixth diode 420 to the second processor switch 428—in other words, the current drawn by the second processor 404 when the second processor switch 428 is closed. The third current sensor 432 provides the value of the measured current to the first networking module 308.

The second processor switch 428 is operated by the second networking module 408. The second networking module 408 may keep the second processor switch 428 open until a wake-up command is received—for example, from the ECM 106. In response to receiving the wake-up command, the second networking module 408 closes the second processor switch 428, such that the second processor 404 is electrically connected to the primary output 212 and the secondary output 216. In other words, the second processor 404 receives power from the primary power supply 184, the secondary power supply 188, or both the primary power supply 184 and the secondary power supply 188. A ninth voltage sensor 436 measures the voltage between the second processor switch 428 and the second processor 404. The ninth voltage sensor 436 provides the value of the measured voltage to the second networking module 408.

In some implementations, the fifth diode 412 and the sixth diode 420 may be Schottky diodes. In other implementations, the fifth diode 412 and the sixth diode 420 may be another diode with a low forward voltage drop and a fast switching speed. In some implementations, the second processor switch 428 may be a MOSFET. In other implementations, the second processor switch 428 may be a relay or another suitable controllable switch.

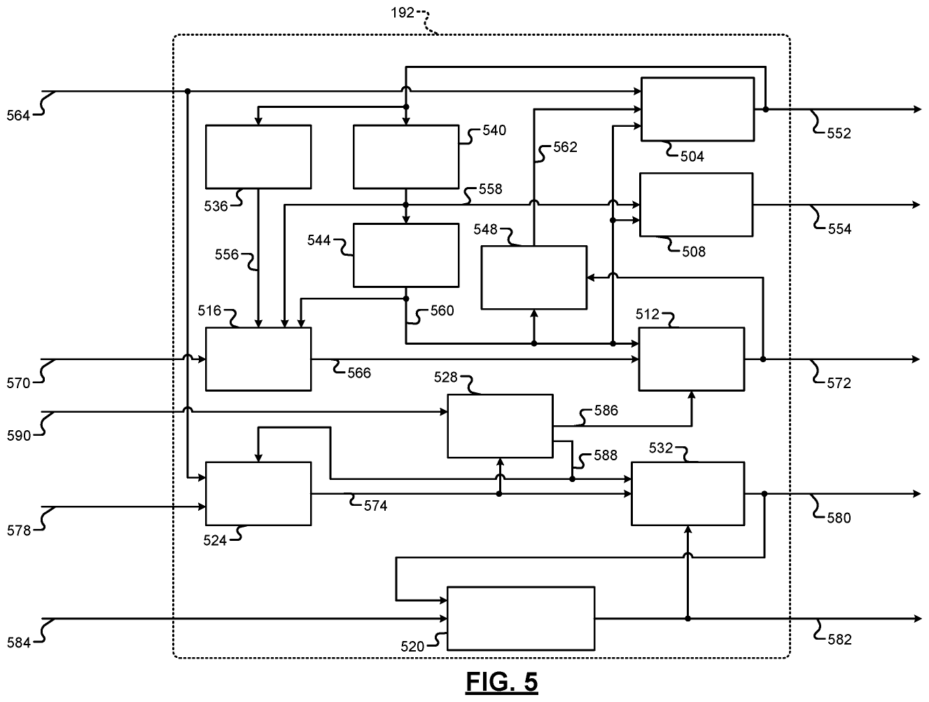

FIG. 5 is a functional block diagram of an example implementation of the PSDM 192. The PSDM 192 may include a first DC/DC control module 504, a second DC/DC control module 508, a DC/DC status module 512, a first voltage comparison module 516, a second voltage comparison module 520, an action request module 524, an action completion module 528, and a switch control module 532. The PSDM 192 may also include a first timer module 536, a second timer module 540, a third timer module 544, and a fourth timer module 548. In some implementations, the PSDM 192 may be a separate module, as shown in FIGS. 1, 2, and 5. In other implementations, the PSDM 192 may be implemented, in whole or in part, in the first controller 204 or the second controller 208. In yet other implementations, the PSDM 192 may be implemented, in whole or in part, in the BCM 180, the ECM 106, or another module of the vehicle.

The first DC/DC control module 504 controls the first variable DC/DC converter 186 of the primary power supply 184 by setting the state of a first DC/DC control signal 552. The second DC/DC control module 508 controls the second variable DC/DC converter 190 of the secondary power supply 188 by setting the state of a second DC/DC control signal 554. Specifically, the state of the first DC/DC control signal 552 controls the output of the first variable DC/DC converter 186 and the state of the second DC/DC control signal 554 controls the output of the second variable DC/DC converter 190. The first timer module 536 sets the state of a first timer signal 556, the second timer module 540 sets the state of a second timer signal 558, the third timer module 544 sets the state of a third timer signal 560, and the fourth timer module 548 sets the state of a fourth timer signal 562.

The first DC/DC control module 504 may set the state of the first DC/DC control signal 552 based on an ignition state 564. For example, in response to the ignition state 564 transitioning from off to on—changing from either off or crank to either accessory or run—the first DC/DC control module 504 transitions the first DC/DC control signal 552 from a first state to a second state. In response to the first DC/DC control signal 552 transitioning from the first state to the second state, the first variable DC/DC converter 186 changes the voltage of the primary output 212 from a first voltage to a second, lower voltage. In one example, the first variable DC/DC converter 186 may adjust the voltage of the primary output 212 from 13.8 V to 12.7 V.

The first timer module 536 generates a first timer value that indicates how long (i.e., a period) the first DC/DC control signal 552 has been in the second state. The first timer module 536 resets the first timer value when the first DC/DC control signal 552 is in the first state. The first timer module 536 increments the first timer value when the first DC/DC control signal 552 is in the second state. When the first timer value is less than a first predetermined period (or value) the first timer module 536 sets the first timer signal 556 to a first state. When the first timer value is equal to or greater than the first predetermined period, the first timer module 536 sets the first timer signal 556 to a second state. For example only, the first predetermined period may be or correspond to approximately a quarter of a second or another suitable period.

The second timer module 540 generates a second timer value that also indicates how long (i.e., a period) the first DC/DC control signal 552 has been in the second state. The second timer module 540 resets the second timer value when the first DC/DC control signal 552 is in the first state. The second timer module 540 increments the second timer value when the first DC/DC control signal 552 is in the second state. When the second timer value is less than a second predetermined period (or value) the second timer module 540 sets the second timer signal 558 to a first state. When the second timer value is equal to or greater than the second predetermined period, the second timer module 540 sets the second timer signal 558 to a second state. The second predetermined period is larger than the first predetermined period. For example only, the second predetermined period may be or correspond to approximately half a second or another suitable period.

The third timer module 544 generates a third timer value that indicates how long (i.e., a period) the second timer signal 558 has been in the second state. The third timer module 544 resets the third timer value when the second timer signal 558 is in the first state. The third timer module 544 increments the third timer value when the second timer signal 558 is in the second state. When the third timer value is less than a third predetermined period (or value) the third timer module 544 sets the third timer signal 560 to a first state. When the third timer value is equal to or greater than the third predetermined period, the third timer module 544 sets the third timer signal 560 to a second state. In some implementations, the third predetermined period may be or correspond to approximately one second. In other implementations, the third predetermined period may be or correspond to approximately 1-5 seconds or another suitable period.

The second DC/DC control module 508 may set the state of the second DC/DC control signal 554 based on the second timer signal 558 and the third timer signal 560. The second DC/DC control module 508 sets the second DC/DC control signal 554 to a first state when the second timer signal 558 transitions from the first state to the second state. The second DC/DC control module 508 sets the second DC/DC control signal 554 to a second state when the third timer signal 560 transitions from the first state to the second state. In response to the second DC/DC control signal 554 being set to the first state, the second variable DC/DC converter 190 changes the voltage of the secondary output 216 from a third voltage to a fourth, higher voltage. In one example, the second variable DC/DC converter 190 may adjust the voltage of the secondary output 216 from 12 V to 15.5 V. In response to the second DC/DC control signal 554 being set to the second state, the second variable DC/DC converter 190 changes the voltage of the secondary output 216 from the fourth voltage back to the third voltage.

The first voltage comparison module 516 generates a voltage comparison signal 566 based on a processor voltage 570. In an example implementation, the processor voltage 570 may be a voltage measured by the third voltage sensor 328 of the first controller 204. In other implementations, the processor voltage 570 may be a voltage measured by the seventh voltage sensor 416 of the second controller 208. In response to the first timer signal 556 transitioning from the first state to the second state, the first voltage comparison module 516 stores the value of the processor voltage 570 and resets a first counter to zero. In response to the second timer signal 558 transitioning from the first state to the second state, the first voltage comparison module 516 begins sampling the value of the processor voltage 570 at a predetermined frequency and compares each sampled value to the stored value. For example only, the first voltage comparison module 516 may sample the processor voltage 570 every 12.5 milliseconds (80 Hertz). In other examples, the first voltage comparison module 516 may sample the processor voltage 570 at another suitable frequency.

The first voltage comparison module 516 increments the first counter by one for each sampled value that is greater than the stored value by a first predetermined threshold. For example only, the first predetermined threshold value may be two. In other examples, the first predetermined threshold is one or another suitable value that indicates that the sampled voltage is associated with the fourth voltage of the second variable DC/DC converter 190—in other words, the secondary output 216. When the first counter is less than a second predetermined threshold, the first voltage comparison module 516 sets the voltage comparison signal 566 to a first state. When the first counter is equal to or greater than the second predetermined threshold, the first voltage comparison module 516 sets the voltage comparison signal 566 to a second state that indicates that the second variable DC/DC converter 190 and the secondary power supply 188 are correctly connected and properly functioning. For example only, the second predetermined threshold may be 40. In other examples, the second predetermined threshold is a value that is proportional to the number of sampled values during the second predetermined period—for example 50% of the number of sampled values or another suitable value.

The DC/DC status module 512 determines a status of a diagnostic trouble code (DTC) of the second variable DC/DC converter 190 and sets a DC/DC DTC signal 572 based on status. The DC/DC status module 512 may set the DC/DC DTC signal 572 based on the third timer signal 560 and the voltage comparison signal 566. In response to the third timer signal 560 being in the second state and the voltage comparison signal 566 being in the first state, the DC/DC status module 512 sets the DC/DC DTC signal 572 to a first state that indicate a pass. In response to the third timer signal 560 being in the second state and the voltage comparison signal 566 being in the second state, the DC/DC status module 512 sets the DC/DC DTC signal 572 to a second state that indicates a fail. Setting the DC/DC DTC signal 572 to the second state may change an operating parameter of the vehicle. For example, setting the DC/DC DTC signal 572 to the second state may cause an indicator lamp to be illuminated and/or place the vehicle in a latent fault mode. When the vehicle is placed in the latent fault mode, the ECM 106 and/or the BCM 180 may limit the number of permitted key cycles. In other words, the vehicle may only be started a limited number of times.

The fourth timer module 548 generates a fourth timer value that indicates how long (i.e., a period) the DC/DC DTC signal 572 been in the first state. The fourth timer module 548 resets the fourth timer value when the third timer signal 560 is in the second state. The fourth timer module increments the fourth timer value when the DC/DC DTC signal 572 is in the second first state. When the fourth timer value is less than a fourth predetermined period (or value) the fourth timer module 548 sets the fourth timer signal 562 to a first state. When the fourth timer value is equal to or greater than the fourth predetermined period, the fourth timer module 548 sets the fourth timer signal 562 to a second state. In some implementations, the fourth predetermined period may be or correspond to approximately 5 minutes. In other implementations, the fourth predetermined period may be or correspond to approximately 10 minutes, 30 minutes, or another suitable period.

The first DC/DC control module 504 may also set the state of the first DC/DC control signal 552 based the third timer signal 560 or the fourth timer signal 562. The first DC/DC control module 504 sets the first DC/DC control signal 552 to the first state when the third timer signal 560 transitions from the first state to the second state. In response to the first DC/DC control signal being in the first state, the first variable DC/DC converter 186 changes the voltage of the primary output 212 to the first voltage level. The first DC/DC control module 504 may set the first DC/DC control signal 552 to the second state when the fourth timer signal 562 transitions from the first state to the second state and the ignition state 564 is on—either accessory or run. In this way, the power supply diagnostics system 200 continues to verify that the second variable DC/DC converter 190 of the secondary power supply 188 is correctly connected and properly functioning while the vehicle is on.

The action request module 524 generates a power supply selection signal 574 based on the number of times the driver 312 of the first controller 204 is requested to perform an action. The power supply selection signal indicates whether both the primary output 212 and the secondary output 216 should be connected to the driver 312 of the first controller 204. In response to the ignition state 564 transitioning from off to on—for example, changing from either off or crank to either accessory or run—the action request module 524 resets a second counter to zero. In response to receiving a request for an action (“action request”) 578, the action request module 524 increments the second counter by one. For example only, the requested action may be to shift the transmission 110 into park. When the second counter is less than a third predetermined threshold, the action request module 524 sets the power supply selection signal 574 to a first state that indicates that both the primary output 212 and the secondary output 216 should be connected to the driver 312. When the second counter is equal to or greater than the second predetermined threshold, the action request module 524 sets the power supply selection signal 574 to a second state that indicates that only the secondary output 216 should be connected to the driver 312. In some implementations, the third predetermined threshold is 10. In other implementations, the third predetermined threshold is another suitable value.

The switch control module 532 controls the operations of the first driver switch 332 and the second driver switch 340 of the first controller 204. The switch control module 532 sets the state of a driver switch control signal 580. When the power supply selection signal 574 is in the first state, the switch control module 532 sets the driver switch control signal 580 to a first state. In response to the driver switch control signal 580 being set to the first state, the first networking module 308 closes both the first driver switch 332 and the second driver switch 340. When the power supply selection signal 574 is in the second state, the switch control module 532 sets the driver switch control signal 580 to a second state. In response to the driver switch control signal 580 being set to the second state, the first networking module 308 opens the first driver switch 332 and closes the second driver switch 340.

The second voltage comparison module 520 determines a DTC status of the first driver switch 332 of the first controller 204. The second voltage comparison module 520 sets the state of a switch DTC signal 582 based on the driver switch control signal 580 and an applied voltage 584 associated with the first driver switch 332. In some implementations, the applied voltage 584 may be a voltage measured by the fourth voltage sensor 338 of the first controller 204. The second voltage comparison module 520 determines whether the applied voltage 584 is less than or equal to a fourth predetermined threshold. In some implementations, the fourth predetermined threshold may be zero. In other implementations, the fourth predetermined threshold is approximately zero or another suitable value.

When the driver switch control signal 580 is in the second state and the applied voltage 584 is less than or equal to the fourth predetermined threshold, the second voltage comparison module 520 determines that the first driver switch 332 has properly functioned and sets the switch DTC signal 582 to a first state that indicates passage. When the driver switch control signal 580 is in the second state and the applied voltage 584 is greater than the fourth predetermined threshold, the second voltage comparison module 520 determines that the first driver switch 332 has not properly functioned and sets the switch DTC signal 582 to a second state that indicates failure. Setting the switch DTC signal 582 to the second state may change an operating parameter of the vehicle. For example, setting the switch DTC signal 582 to the second state may cause an indicator lamp to be illuminated and/or place the vehicle in the latent fault mode.

Independently of the power supply selection signal 574, the switch control module 532 may set the state of the driver switch control signal 580 based on the switch DTC signal 582. The switch control module 532 may close the first driver switch 332 in response to the second voltage comparison module 520 determining that the first driver switch 332 has not operated properly. Specifically, when the switch DTC signal 582 is in the second state, the switch control module 532 sets the driver switch control signal 580 to the first state.

The action completion module 528 determines whether the driver 312 of the first controller 204 completes a requested action while only connected to the secondary output 216. In other words, when the first driver switch 332 of the first controller 204 is open and the second driver switch 340 of the first controller 204 is closed. The action completion module 528 sets the state of an action completion signal 586 and an action reset signal 588 based on the power supply selection signal 574 and a sensor value 590 associated with the requested action. In response to the power supply selection signal 574 being in the first state, the action completion module 528 sets the state of the action reset signal 588 to a first state. In response to the power supply selection signal 574 being in the second state, the action completion module 528 determines whether the requested action has been competed based on the received sensor value 590.

In one example implementation, the sensor value 590 may be a driver current measured by the second current sensor 348 of the first controller 204. The action completion module 528 may compare the sensor value 590 to a current value that corresponds to a completed action. In response to the sensor value 590 being equal to or greater than the current value that corresponds to a completed action, the action completion module 528 determines that the requested action was completed. Otherwise, the action completion module 528 determines that the requested action was not completed. In another example, the sensor value 590 may correspond to a sensor signal that indicates that the requested action was completed. For example, the sensor value 590 may be from the TCM 114 and indicates whether the transmission 110 is in park. The action completion module 528 compares the sensor value 590 with a sensor value that corresponds to a completed action. In response to the sensor value 590 being equal to the sensor value that corresponds to a completed action, the action completion module 528 determines that the requested action was completed. Otherwise, the action completion module 528 determines that the requested action was not completed.

When the action completion module 528 determines that the requested action has been completed, the action completion module 528 sets the action completion signal 586 to a first state and the action reset signal 588 to a second state. When the action completion module 528 determines that the requested action was not completed, the action completion module sets the action completion signal 586 to a second state and the action reset signal 588 to the second state.

Independently of the third timer signal 560 and the voltage comparison signal 566, the DC/DC status module 512 may set the state of the DC/DC DTC signal 572 based on the action completion signal 586. Specifically, when the action completion signal 586 is in the second state, the DC/DC status module 512 sets the DC/DC DTC signal 572 to the second state.

The action request module 524 may reset the second counter based on the action reset signal 588. Specifically, when the action reset signal 588 is in the second state, the action request module 524 resets the second counter. In this way, the power supply diagnostics system 200 may continue to test the secondary power supply 188 after receiving a specific number of action requests based on the fourth predetermined threshold. For example only, the power supply diagnostics system 200 may use the secondary output 216 of the secondary power supply 188 to shift the transmission 110 into park every tenth request to shift into park.

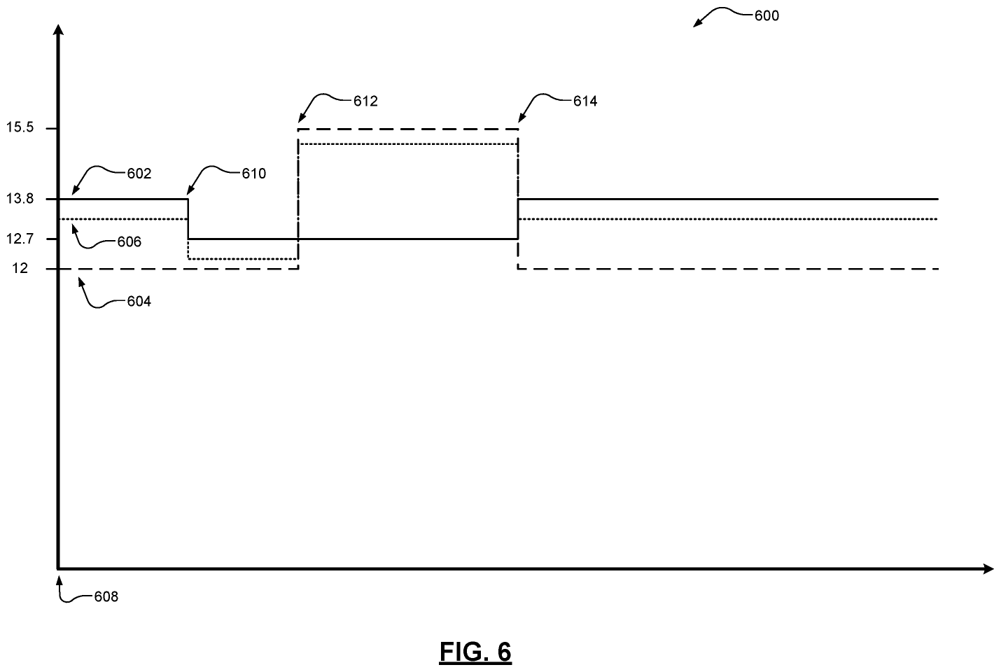

FIG. 6 is a graph 600 showing illustrative sensed voltage levels over time according to one example implementation of the power supply diagnostics system 200. A first sensed voltage 602 represents the voltage of the primary output 212—for example as measured by the first voltage sensor 317 of the first controller 204. A second sensed voltage 604 represents the voltage of the secondary output 216—for example, as measured by the second voltage sensor 319. A third sensed voltage 606 represents the voltage at the first processor 304, as measured by the third voltage sensor 328 when the first processor switch 324 is closed. The third sensed voltage 606 also represents the voltage at the second processor 404, as measured by the ninth voltage sensor 436 when the second processor switch 428 is closed.

A first time 608 represents a starting time—for example, when the ignition is first turned on—of the example implementation of the power supply diagnostics system 200. At the first time 608, the first sensed voltage 602 is 13.8 V and the second sensed voltage 604 is 12 V. The third sensed voltage 606 is approximately 13.3 V—in other words, 13.8 V minus the voltage drop across a diode, for example, the first diode 316. A second time 610 represents a time when the output of the primary power supply 184 is changed from the first level to the second level. At the second time 610, the first sensed voltage 602 drops to 12.7 V, while the second sensed voltage 604 remains at 12 V. At the second time 610, the third sensed voltage 606 drops to approximately 12.2 V—in other words, 12.7 V minus the voltage drop across a diode.

A third time 612 represents a time when the output of the secondary power supply 188 is changed from the third voltage to the fourth voltage. At the third time 612, the second sensed voltage 604 rises to 15.5 V and the third sensed voltage 606 rises to approximately 15 V—in other words, 15.5 V minus the voltage drop across a diode. At the third time 612, the first sensed voltage 602 remains at 12.7 V. A fourth time 614 represents a time when the output of the primary power supply 184 is changed from the second voltage back to the first voltage and when the output of the secondary power supply 188 is changed from the fourth voltage back to the third voltage. At the fourth time 614, the first sensed voltage 602 rises to 13.8 V and the second sensed voltage 604 drops to 12 V. At the fourth time 614, the third sensed voltage 606 drops to approximately 13.3 V.

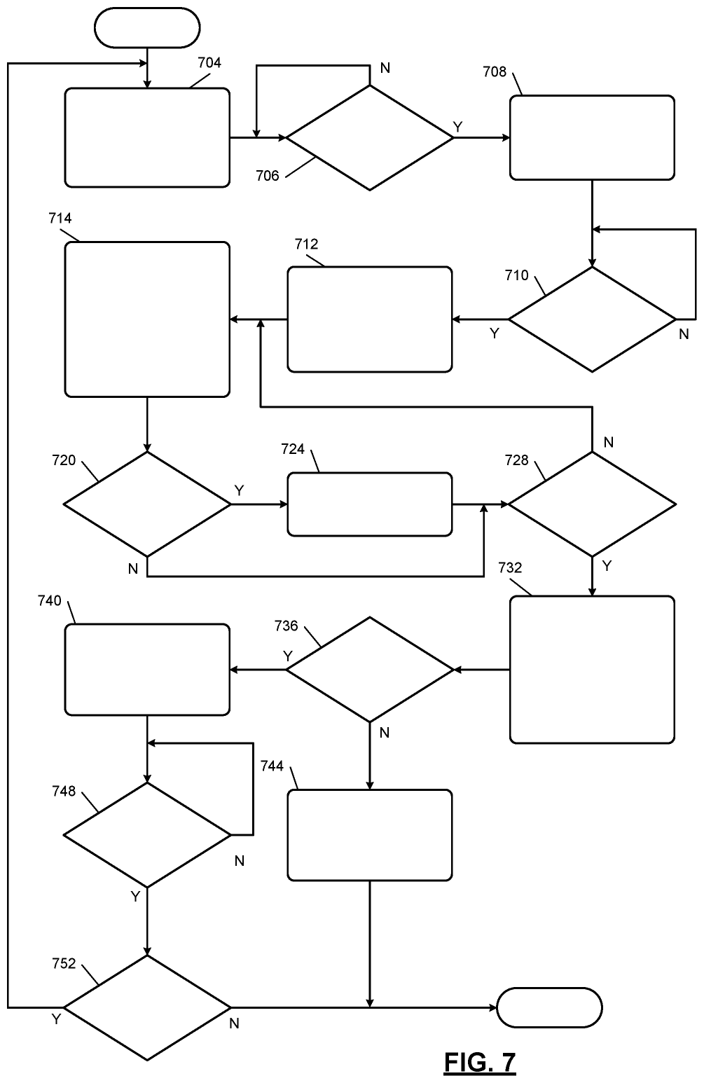

FIG. 7 is a flowchart depicting an example method of verifying that a backup power supply is able to provide power to a controller. Although the example method is described below with respect the power supply diagnostics system 200, the method may be implemented in other systems that have a main power supply and a backup power supply—for example, a main APM and a backup APM. In various implementations, control may be performed by the PSDM 192. In other implementations, control may be performed by the power supply diagnostics system 200. Control begins with 704, in response to the ignition being turned on.

At 704, control reduces the voltage outputted by a first power supply from a first voltage to a second voltage. For example, the PSDM 192 may switch the output voltage of the first variable DC/DC converter 186 of the primary power supply 184 from 13.8 V to 12.7 V. At 704, control also resets and starts a first timer and a second timer. Control progresses to 706 where control determines whether the first timer is equal to or greater than a first predetermined period of time. If so, control continues with 708; otherwise, control returns to 706. For example only, the first predetermined period of time may be or correspond to approximately a quarter of a second or another suitable period.

At 708, control measures and stores the value of a processor voltage of the controller and resets a counter to zero. For example, the PSDM 192 may receive and store the voltage value measured by the third voltage sensor 328 of the first controller 204. Control then progresses to 710. At 710, control determines whether the second timer is equal to or greater than a second predetermined period of time. If so, control progresses to 712; otherwise control returns to 710. The second predetermined period of time is larger than the first predetermined period of time. For example only, the second predetermined period of time may be or correspond to approximately half a second or another suitable period.

At 712, control increases the voltage outputted by a second power supply from a third voltage to a fourth voltage, such that the fourth voltage is greater than the second voltage outputted by the first power supply. For example, the PSDM 192 may switch the output voltage of the second variable DC/DC converter 190 of the secondary power supply 188 from 12 V to 15.5 V. At 712, control also resets and starts a third timer. Control then continues with 714.

At 714, control samples the voltage at the controller at a predetermined frequency and calculates the difference between the sampled voltage and the stored voltage. Control progresses to 720. At 720, control determines whether the calculated difference is greater than a predetermined first threshold value. For example, the PSDM 192 may determine whether the sampled voltage value is greater than the stored voltage by at least two volts. If so, control continues with 724 where control increments the counter by one and then control progresses to 728. If control determines that the received voltage is not greater than the stored voltage by at least the first threshold value, control transfers to 728.

At 728, control determines whether the third timer is equal to or greater than a third predetermined period of time. If so, control continues with 732; otherwise, control returns to 714. In some implementations, the third predetermined period of time may be or correspond to approximately one second. In other implementations, the third predetermined period of time may be or correspond to approximately 1-5 seconds or another suitable period.

At 732, control reduces the voltage outputted by the second power supply from the fourth voltage back to the second voltage and increases the voltage outputted by the first power supply from the second voltage back to the first voltage. For example, the PSDM 192 may switch the output voltage of the second variable DC/DC converter 190 of the secondary power supply 188 from 15.5 V to 12 V and the output voltage of the first variable DC/DC converter 186 of the primary power supply 184 from 12.7 V to 13.8 V. Control then progresses to 736.

At 736, control determines whether the counter is greater than or equal to a second threshold value. If so, control determines that the secondary power supply is properly connected to the controller and functioning correctly. For example, the secondary power supply 188 and the second variable DC/DC converter 190 are both properly connected to the controller and functioning correctly. Control then continues with 740. At 740, control sets a DTC for the second power supply to pass and resets and starts a fourth timer. Control then progresses to 748, as described below.

If at 736, control determines that the counter is less than the second threshold value, control determines that the second power supply is not properly functioning and/or correctly connected to the controller and control transfers to 744. For example, the secondary power supply 188 and the second variable DC/DC converter 190 are not properly functioning and/or that the secondary power supply 188 and the second variable DC/DC converter 190 are not correctly connected to the first controller 204. At 744, control sets the DTC for the secondary power supply to fail. Control then ends.

At 748, control determines whether the fourth timer is equal to or greater than a fourth predetermined period of time. If so, control continues with 752; otherwise, control returns to 748. In some implementations, the fourth predetermined period of timer may be or correspond to approximately 5 minutes. In other implementations, the fourth predetermined period of time may be or correspond to approximately 10 minutes, 30 minutes, or another suitable period.

At 752, control determines whether the ignition is on. For example, the ignition state 564 is either accessory or run. If so, control returns to 704; otherwise, control ends.

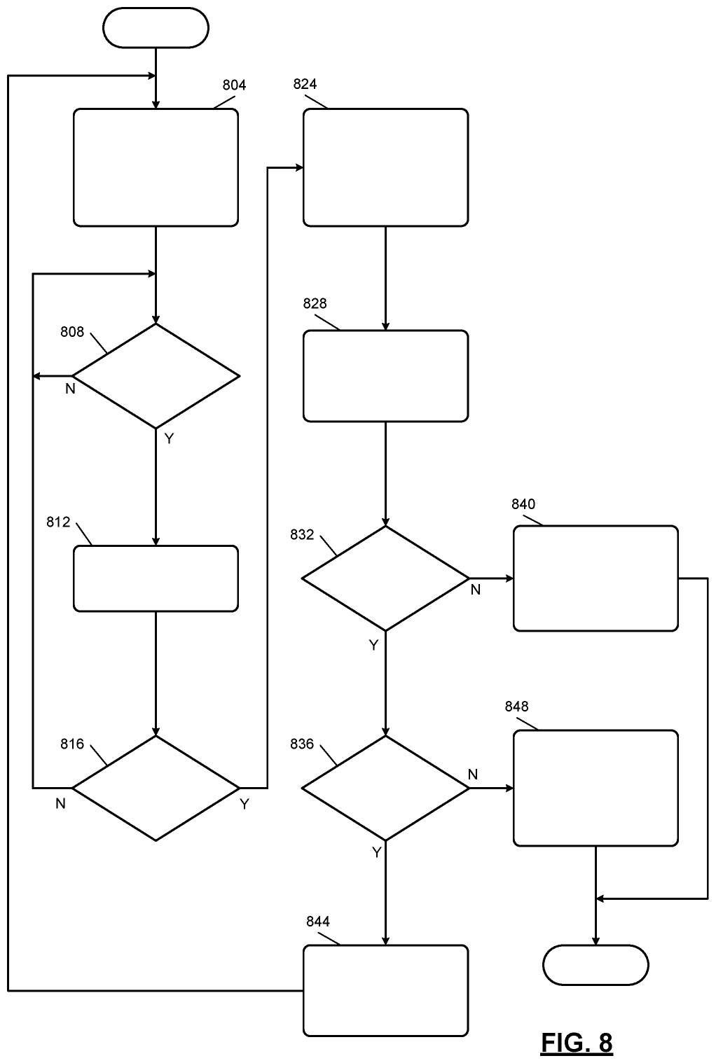

FIG. 8 is a flowchart depicting an example method of verifying that a backup power supply is able to provide the current necessary for a controller to perform an action that draws a high current. Although the example method is described below with respect to the power supply diagnostics system 200, the method may be implemented in other systems that have a main power supply and a backup power supply—for example, a main APM and a backup APM. In various implementations, control may be performed by the PSDM 192. In other implementations, control may be performed by the power supply diagnostics system 200. Control begins with 804, in response to the ignition being turned on.

At 804, control causes a driver of the controller to be powered by the first power supply. For example, the PSDM 192 causes the first driver switch 332 to be closed. At 804, control also sets a request counter to zero. Control then progresses to 808.

At 808, control determines whether an action has been requested. If so, control continues with 812; otherwise, control returns to 808. At 812, control increments the request counter by one and then control continues with 816. At 816, control determines whether the value of the request counter is equal to or greater than a predetermined threshold value. In other words, control determines if the number of requests is reached the predetermined threshold value. In some implementations, the predetermined threshold value is 10. In other implementations, the predetermined threshold value may be any other suitable value. If control determines that value of the request counter is equal to or greater than the predetermined threshold value, control continues with 824; otherwise control returns to 808.

At 824, control causes the driver of the controller to be powered only by the second power supply. For example, the PSDM 192 instructs the first networking module 308 to (i) open the first driver switch 332 and (ii) close the second driver switch 340. Control then progresses to 828 where control measures the voltage applied to the driver of the controller by the first power supply. For example, the PSDM 192 receives the voltage measured by the fourth voltage sensor 338. Control then continues with 832.

At 832, control determines whether the measured voltage is less than or equal to a second predetermined threshold. In some implementations, the second predetermined threshold may be zero. In other implementations, the second predetermined threshold is approximately zero or another suitable value. If the measured voltage is less than or equal to the second predetermined threshold, control determines that a driver switch associated with the first power supply is operating correctly and control continues with 836. If the measured voltage is greater than the second predetermined threshold, control determines that the driver switch associated with the first power supply is not operating correctly and control transfers to 840. For example, the PSDM 192 determines that the first driver switch 332 is not disconnecting the primary output 212 from the driver 312 of the first controller 204. At 840, control sets a DTC for the driver switch associated with the first power supply to fail and causes the driver of the controller to be powered by the first power supply. For example, the PSDM 192 sets a DTC for the first driver switch 332 to fail and instructs the first networking module 308 to close the first driver switch 332. Control then ends.

At 836, control determines if the requested action was performed. In some implementations, control may determine if the action is performed based on the current drawn by the driver of the controller. For example, the PSDM 192 may receive the driver current measured by the second current sensor 348 and compare it to a value that corresponds to a completed action—such as shifting the transmission 110 into park. In other implementations, control may determine if the action is performed based on a signal received from a sensor associated with the action. For example, the PSDM 192 may receive a signal that indicates that the transmission 110 has been shifted into park.

If at 836, control determines that the action has been performed, control continues with 844 where control sets a DTC for the second power supply to pass. Control then returns to 804. If at 836, control determines that the action was not performed, control determines that the second power supply is not able to supply the driver of the controller with the necessary current and control transfers to 848. At 848, control sets the DTC for the second power supply to fail and causes the driver of the controller to be powered by the first power supply. For example, the PSDM 192 sets a DTC for the secondary power supply 188 to fail instructs the first networking module 308 to (i) close the first driver switch 332 and (ii) open the second driver switch 340. Control then ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A power supply diagnostics system comprising:
a first direct current to direct current (DC/DC) control module configured to change an output of a first variable DC/DC converter from a first voltage to a second voltage, wherein the output of the first variable DC/DC converter is connected to a load;
a first timer module configured to set a first signal to first state when the output of the first variable DC/DC converter is the second voltage for a first predetermined period;
a second DC/DC control module configured to change an output of a second variable DC/DC converter from a third voltage to a fourth voltage when the first signal is in the first state, wherein the output of the second variable DC/DC converter is connected to the load;
a second timer module configured to set a second signal to first state when the output of the first variable DC/DC converter is the second voltage for a second predetermined period;
a first voltage comparison module configured to (i) store a fifth voltage measured at the load when the second signal is in the first state and (ii) begin sampling a plurality of voltages measured at the load when the first signal is in the first state; and
a DC/DC status module configured to change an operating parameter of a vehicle based on a comparison of the fifth voltage and the plurality of voltages.

2. The power supply diagnostics system of claim 1 wherein the first voltage comparison module is configured to:
set a first counter to zero in response to the second signal being in the first state; and
increment the first counter for each voltage of the plurality of voltages that is greater than the fifth voltage by a first predetermined threshold.

3. The power supply diagnostics system of claim 2 further comprising a third timer module configured to set a third signal to a first state when the output of the second variable DC/DC converter is the fourth voltage for a third predetermined period,
wherein the first voltage comparison module is configured to:
stop sampling the plurality of voltages when the third signal is in the first state,
compare a value of the first counter to a second predetermined threshold,
set a fourth signal to a first state when the value of the first counter is less than or equal to the second predetermined threshold, and
set the fourth signal to a second state when the value of the first counter is greater than the second predetermined threshold.

4. The power supply diagnostics system of claim 3 wherein the DC/DC status module is configured to:
set a status of the second variable DC/DC converter to a fail when the third signal is in the first state and the fourth signal is in the first state, and
set the status of the second variable DC/DC converter to a pass when the third signal is in the first state and the fourth signal is in the second state.

5. The power supply diagnostics system of claim 1 wherein sampling the plurality of voltages includes sampling the voltage at the load at a predetermined sampling frequency.

6. The power supply diagnostics system of claim 1 wherein:
the first predetermined period is longer than the second predetermined period,
the second voltage is lower than the first voltage,
the third voltage is lower than the second voltage, and
the fourth voltage is higher than the first voltage.

7. The power supply diagnostics system of claim 1 further comprising:
an action request module configured to:
reset a second counter based on the state of an ignition of the vehicle,
increment the second counter in response to receiving a request to perform an action,
set a fifth signal to a first state when a value of the second counter is less than a third predetermined threshold, and
set the fifth signal to a second state when the value of the second counter is equal to the third predetermined threshold; and
a switch control module configured to:
close a first switch when the fifth signal is in the first state, and
open the first switch and close a second switch when the fifth signal is in the second state,
wherein (i) a first end of the first switch is electrically connected to the output of the first variable DC/DC converter and (ii) a first end of the second switch is electrically connected to the output of the second variable DC/DC converter.

8. The power supply diagnostics system of claim 7 further comprising a second voltage comparison module configured to:
compare a sixth voltage associated with a second end of the first switch to a fourth predetermined threshold when the switch is open;
set a status of the first switch to a pass when the sixth voltage is less than or equal to the fourth predetermined threshold; and
set the status of the first switch to a fail when the sixth voltage is greater than the fourth predetermined threshold.

9. The power supply diagnostics system of claim 8 further comprising an action completion module configured to determine whether a requested action is completed when the fifth signal is in the second state,
wherein the DC/DC status module is configured to set the status of the second variable DC/DC converter to fail in response to the action completion module determining that the requested action is not completed.

10. The power supply diagnostics system of claim 9 wherein:
the first switch and second switch are located in a transmission control module of the vehicle, and
the requested action includes shifting a transmission of the vehicle into park.

11. A power supply diagnostics method comprising:
changing an output of a first variable direct current to direct current (DC/DC) converter from a first voltage to a second voltage, wherein the output of the first variable DC/DC converter is connected to a load;
measuring and storing, in response to changing the output of the first variable DC/DC converter to the second voltage, a third voltage at the load;
changing an output of a second variable DC/DC converter from a fourth voltage to a fifth voltage, wherein the output of the second variable DC/DC converter is connected to the load;
in response to changing the output of the second variable DC/DC converter to the fifth voltage, measuring a plurality of voltages at the load; and
setting an operating parameter of a vehicle based on a comparison of the third voltage and the plurality of voltages.

12. The power supply diagnostics method of claim 11 further comprising:
setting a counter to zero in response to changing the output of the first variable DC/DC converter to the second voltage;
for each voltage of the plurality of voltages that is greater than the third voltage by a first predetermined threshold, incrementing the counter; and
comparing a value of the counter to a second predetermined threshold,
wherein setting the operating parameter of the vehicle includes, in response to determining that the value of the counter is less than a second predetermined threshold, setting a status for the second variable DC/DC converter to a fail.

13. The power supply diagnostics method of claim 11 wherein:
the second voltage is lower that the first voltage,
the fourth voltage is lower than the second voltage, and
the fifth voltage is higher than the first voltage.

14. The power supply diagnostics method of claim 11 wherein measuring the plurality of voltages includes sampling voltages at the load at a predetermined sampling frequency for a predetermined sampling period.

15. The power supply diagnostics method of claim 14 wherein the predetermined sampling frequency is 80 Hertz and the predetermined sampling period is one second.

16. A power supply diagnostics method comprising:
closing a first switch of a controller, wherein a first end of the first switch is electrically connected to an output of a first variable direct current to direct current (DC/DC) converter and a second end of the first switch is electrically connected to a driver of the controller;
receiving a request to perform an action;
in response to receiving the request, selectively (i) opening the first switch and (ii) closing a second switch, wherein a first end of the second switch is electrically connected to an output of a second variable DC/DC converter and a second end of the second switch is electrically connected to the driver;
determining whether the requested action is completed; and
in response to determining that the requested action is not completed, changing an operating parameter of a vehicle.

17. The power supply diagnostics method of claim 16 further comprising:
in response to opening the first switch, measuring a voltage of the second end of the first switch;
comparing the measured voltage of the second end of the first switch to a first predetermined threshold; and
in response to determining that the measured voltage is greater than the first predetermined threshold, setting a status of the first switch to a fail.

18. The power supply diagnostics method of claim 17 further comprising:
in response to receiving the request to perform an action, incrementing a counter; and
comparing a value of the counter to a second predetermined threshold,
wherein selectively (i) opening the first switch and (ii) closing the second switch includes opening the first switch and closing the second switch in response to determining that the value of the counter is equal to or greater than the second predetermined threshold.

19. The power supply diagnostics method of claim 18 wherein:
determining whether the requested action is completed includes:
receiving a sensor value associated with the requested action;
determining whether the requested action is completed based on the received sensor value; and
changing the operating parameter of the vehicle includes, in response to (i) opening the first switch, (ii) closing the second switch, and (iii) determining that the requested action is not completed, setting a status of the second variable DC/DC converter to a fail.

20. The power supply diagnostics method of claim 16 wherein:
the controller is a transmission control module of a vehicle, and
completing the requested action includes shifting a transmission of the vehicle into park.
